(19) United States
(12) Patent Application Publication
(10) Pub. No.: US 2007/0245010 A1
(43) Pub. Date: Oct. 18, 2007

(54) SYSTEMS AND METHODS FOR MULTI-PERSPECTIVE OPTIMIZATION OF DATA TRANSFERS IN HETEROGENEOUS NETWORKS SUCH AS THE INTERNET

(76) Inventors: Robert Arn, Kelowna (CA); Thomas Taylor, Kelowna (CA); Jonathon Balogh, Kelowna (CA); Justin McMichael, Kelowna (CA); Kevin Matrosovs, Kelowna (CA); Shawn Sterling, Westbank (CA)

Correspondence Address: VERMETTE & CO., SUITE 320 - 1177 WEST HASTINGS STREET, VANCOUVER, BC, V6E2K3, CA

(21) Appl. No.: 11/690,773

(22) Filed: Mar. 23, 2007

Related U.S. Application Data
(60) Provisional application No. 60/767,389, filed on Mar. 24, 2006.

(51) Int. Cl. G06F 15/173

(52) U.S. Cl. 709/223

(57) ABSTRACT

Systems and methods are described for optimizing network data transfers using multiple classes of network resources and network intelligence gathered and integrated by a multi-perspective network optimizer so as to maximize the performance, scalability and commercial controllability and minimize the cost of network data transfers in heterogeneous networks such as the internet.

### FIELD OF THE INVENTION

This invention pertains to the transfer of data across heterogeneous networks such as the internet. More specifically, it describes systems and methods for optimizing the utilization of network infrastructure so as to maximize the performance, scalability and commercial controllability and to minimize the cost of network data transfers.

### BACKGROUND OF THE INVENTION

The World Wide Web on the Internet has become the predominant network through which people organize, find and consume textual and graphic information The base protocol of the Web, the Hypertext Transfer Protocol (HTTP) has proved to be an efficient and robust mechanism to manage the transfer of such textual and graphics files from servers to client computers where they are assembled and rendered as composite pages in browsers.

Increasingly, efforts are being made to use the internet and the Web as a delivery and presentation network for rich media such as video, audio and animation. Two basic approaches have emerged to deliver such new content.

The first, server-centric approach has either file-download or streaming server alternatives File download users request a simple download of the media file from a file server, which, after the whole file has been transferred, may be loaded and played in a media player. This approach has become very widespread with regard to audio files and increasingly common with video files The file transfers may utilize one of several standard internet protocols—HTTP, FTP, SMPT.

An alternative server-centric method called media streaming has been developed to circumvent the limitations of the file download approach. In this approach, a specialized streaming server organizes the media data into a format that allows the media to be played immediately as soon as data has begun to be received from the server by the client rather than waiting until the whole file has been received. Typically, there is a short buffering delay before the media starts playing.

FIG. 1A shows a prior art server-centric data transport system comprising a Server 101 with Data Storage 102 which is a data supply resource of Bound Service Resources 100 communicating with a plurality of client computers Client 301A to Client 301N all part of Bound Client Resources 300 through a network such as the Internet which may contain a variety of server resources Unbound Network Resources 220. The term “Bound” is taken to mean, in the case of Bound Service Resources 100, a server that is under the control of the party that is providing the data distribution service to clients. In the case of Bound Client Resources 300, the term “Bound” is taken to mean that the Clients 301A to 301N all contain software functions to participate in the data transfer protocol offered by the Server 101. Such protocols may be standard internet protocols such as HTTP, SMTP, FTP and others, or may be custom protocols such as streaming protocols provided by Real Networks®, Microsoft® and others. An exemplary session would initiate from a client such as Client 301A with a file or stream request Client Request 311A according to the protocol supported by the Server 101. Server 101 retrieves the data from Data Storage 102 and sends it according to the protocol as Server Data 312A to Client 301A where it is processed according to the application(s) supported by Client 301A which are capable of interpreting the data. The applications might be an audio or video player or other application. Although the data may pass through a plurality of Unbound Network Resources 220 in the network such as switches and proxy servers, neither the Server 101 nor the Client 301A have any control over such resources which are termed “Unbound” because they are not directly under the control of either servers or clients in the system although they may respond transparently to standard protocol directives from both clients and server.

Such server-centric systems are simple and robust under stable conditions; they can, to a degree, support one of the key network optimization goals, that of commercial controllability, since all data requests pass through a single point of control However, the characteristics of the other three key optimization variables, performance, scalability, and cost are less than ideal, all because of the concentration of service demand at a single point in the server. Each client request must be handled as a separate session between the server and the client on a one-to-one basis. Server 101 must provide the data for every request from all of the clients, Client 301A to Client 301N. Typically, the whole system is based on a single protocol, which may not be optimal under all circumstances. Scalability and performance can be stable as long as the capacity of Server 101 exceeds the total of all requests. At the point that total client demand exceeds the capacity of Server 101 then any increase in scaling must introduce a decrease in performance. Responding to such over-capacity demand is not smooth. New server resources must be introduced, either by increasing the capacity of Server 101, or by introducing a more complex server architecture as shown below in FIG. 1B. To ensure smooth scaling characteristics, server-centric systems must plan in advance for peak demands, which leads to a non-optimal cost variable, because provisioning for peak demand usually means that excess capacity must be paid for which is not used in normal operations. As well, the necessity for such advance planning limits aspects of commercial controllability, since the system may have difficulty maintaining simple aspects of commercial control such as matching service supply with the customer demand for service.

FIG. 1B shows a prior art server-centric system which has been enhanced to allow more flexible and efficient scaling than simply increasing the capacity of a single server as shown in Server 101 of FIG. 1A Client 311A initiates a data request Client Request 312A to Load Balancer 111 which redirects the request to one of a plurality of servers Server 112A to Server 112N, in this case Server 112A, which returns the requested data Server Data 313A to Client 311A. Load Balancer 111 serves as a load balancer among the group Server 112A to Server 112N. At the expense of adding the complexity of Load Balancer 111, this makes it possible to add resources for scaling in a more incremental non-disruptive fashion than replacing or upgrading a single server on the model of FIG. 1A. At its simplest, the architecture of FIG. 1B is a local cluster that can be treated as a single logical server. It has similar commercial control characteristics as the system of FIG. 1A, more smooth scalability, but the same limitations on performance and a cost characteristic that is similar to FIG. 1A, since the system must be provisioned against projected peak demand. However, although there may be a plurality of servers, each client is still served on a one-to-one basis by a single server. This makes the server-centric model subject to performance and efficiency constraints, particularly due to network latency limitations which introduce differential delays, and hence, protocol throughput problems in servicing data requests. These limitations can be particularly severe in supporting streaming protocols. The system of FIG. 1B, however, can be implemented to achieve some gains in performance and efficiency by distributing the Server 112A to Server 112N in different sectors of the overall network. This allows Load Balancer 111 to route data requests not just on the basis of balancing server load, but logically “closer” to the requesting client so as to avoid latency problems due to moving data through inefficient paths in the overall network. Load Balancer 111 can operate not just on a fixed load balancing algorithm, but may retain some knowledge of efficient pathways which may be sourced from tables and algorithms entered into the Load Balancer 111. There is a theoretical possibility that such systems could be redesigned to support multiple protocols, however this has not been implemented in practice. This general architecture is currently used in content delivery networks such as that provided by Akamai Inc. However, relative to ultimate scalability and cost optimization, the system still suffers from the necessity of provisioning to meet peak loads and an increasing burden of system management complexity. Moreover, although the edge network configuration may improve performance by virtue of locating servers on low-latency paths close to each client, the overall efficiency of the system suffers by limiting the load balancing to only choose a server which is close to the requesting client. This leaves distant server resources un-used although they may be available and undermines the efficiency of the overall network. Ultimately, the one server to one client constraint of server centric systems has been impossible to scale while maintaining overall network efficiency.

The second client-centric approach, transfers files using proprietary peer-to-peer protocols (P2P) which reduce transfer costs by exploiting the distributed data storage and computing resources of client computers rather than centralized servers. A user requests a file from one or more peer client computers which deliver the data. When the data transfer is complete, the user may load and play the media in a media player.

FIG. 1C shows a prior art client-centric system comprising a plurality of client computers Client 321A to Client 321N each with storage and software functions to share data with other clients Such systems are currently commonplace in the Internet, called “file-sharing” or “peer to peer” (P2P) networks. In the simplest case, one client, say Client 321A, might request a file from another client, say Client 321B. However, to do so, Client 321A must first have knowledge that Client 321B exists and an address to request the desired data. Two general approaches are used to acquire this preliminary knowledge. A totally distributed system is possible whereby the requesting client need only know the address of a single other client. By a process of clients querying clients, each client can compile a list of addressable sources for desired data. FIG. 1C shows an alternative structure in which the addresses of groupings of clients is stored on a plurality of tracker nodes. In this case Client 321A first makes a Peer Disclosure Query 322A to Peer Tracker 121 which replies with a Peer List 323A. In the simple case above, Client 321A then requests the desired data via Peer Data Requests 324A to Client 321B and the requested data is returned as Peer Data 325A.

However, such point-to-point file transfers are limited by the availability and the upload bandwidth of the client providing the data. Most internet client connections have limited upload bandwidth relative to download bandwidth so that performance is severely limited from the perspective of the requesting client which has much greater reception bandwidth than a single transmitting client can provide. Hence, most client-centric systems exploit parallel requests to multiple supplying clients and rather than sending whole files, break the file down into some sort of subunits so that different supply clients can send different parts of the file to a requesting client in parallel. Receiving clients then must have the capability of reassembling the file parts into a whole file. In this case, Client 321A would request file parts from a selection of clients via Peer Data Requests 324A, say Client 321B and Client 321N, which would reply with Peer Data 325B and Peer Data 325N, which then would be reassembled into the desired file by the requesting client Client 321A. There is a theoretical possibility that such systems could be redesigned to support multiple protocols, however this has not been implemented in practice.

Such client-centric systems have quite different optimization characteristics than server-centric systems. Scalability and cost are extremely favorable. In the extreme, no server resources may be required, the system relying totally on resources provided by the clients themselves and even when external trackers are used, the burden can be minimal in cost. Scalability is achieved with no need to pre-install resources to meet peak demands and each new requesting source adds potential supply resource. There is, however, a hard limit to scalability in client-centric systems imposed by the ratio of client download bandwidth to client upload bandwidth. Most internet client connections provided by ISPs are asymmetrical, delivering from 5 to 10 times less upload bandwidth than download bandwidth This means that each consuming client needs 5 to 10 supplying clients for the bandwidth supply to match demand. Thus, as clients request more bandwidth and the number of clients grows, the systems will reach severe limits on further scalability and available performance.

The key optimization variables of performance and commercial control are not so positive. Commercial control is completely circumvented since there is no point of control. This is not merely incidental, since most of the design energy that has gone into client-centric systems has been to create architectures that circumvent central control, recognizing that one of the primary motivations for the use of the system was file transfers that contravene copyright and other intellectual property rights. A concealed aspect of lack of commercial control and cost relates to the question of what the true cost of client resources is and who should pay for the bandwidth used by client-centric systems. Although the costs of client-centric systems appear low to the end-user client, the architecture of the system forces increased costs on ISPs who must pay internetworking data transfer costs on the traffic in and out of their network. This leads to a motivation for ISPs to limit the bandwidth and Quality of Service (QOS) available to client-centric data distribution systems, negatively impacting performance and potentially scalability.

Performance can be good under certain circumstances where large numbers of supply clients are available for a smaller number of requesting clients However, there is no control on the availability of clients to upload and external factors such as ISP controls and client firewall adoption are beginning to impact performance. Much of the prior art relative to client-centric systems is focused on performance, since cost tends to be regarded as negligible, scalability infinite and commercial control not a goal. Balancing the selection of the best sources against the need not to overload particular sources is a particular concern.

Overall, the approach to network optimization differs between server-centric and client centric systems. Not only are the strengths and weakness of the two systems different, but the resources available to optimize a network from a client perspective is strongly contrasted to the resources available from a server perspective. The information that is available to a server is different than that available to a client. A client can directly access its own configuration data and indirectly learn some of the characteristics of the network sector of which it is a part and information about the limited number of clients that it shares data with, but it cannot access data concerning other clients with which it does not share any transactions. A server can consolidate information from transactions across multiple clients throughout the network, but it does not have direct access to the local resources and characteristics of any particular client.

All current systems represent a tradeoff between negative side-effects One may achieve simplicity and moderate cost in file transfer systems at the cost of sacrificing the immediacy of the users' media experience. The streaming server approach more closely satisfies users' desires for an immediate media experience, at the cost of complexities of network integration and high server and bandwidth costs. It is very difficult to scale streaming servers to large numbers of simultaneous users since they must provide a continuous stream of data to the user over the length of the media experience; and streaming servers typically require more complex interactions between client and server than can be accommodated in the standard Web protocols such as HTTP, FTP and SMTP, necessitating the use of proprietary protocols which in turn introduce difficulties of interaction with user firewalls and other internet infrastructure.

Peer-to-peer systems have significantly lower costs, but share the problems of file transfer systems with regard to user experience deficiencies and the problems of streaming server proprietary protocols with regard to difficulties of interaction with user firewalls and other internet infrastructure. A dominant problem of peer-to-peer systems lies in their lack of any commercial control mechanism which is deeply embedded in their architecture, stemming from their history as anonymous (and often illegal) file sharing networks.

Efforts to optimize networks have differed depending on whether the starting point was server-centric, file transfer or streaming oriented; or was client-centric peer-to-peer oriented. Each optimization approach concentrates on the network component that is accessible and controllable.

Attempts at optimizing server-centric networks have concentrated on solving interlinked problems of scalability and performance. For instance, Akamai Networks has attempted to create a more scalable and high performance network by distributing its serving infrastructure in multiple cache servers distributed throughout the internet. This approach is effective in increasing scalability and performance, but is ineffective at addressing cost, since the network proprietor must still purchase, operate and maintain the distributed cache servers.

The costs of client-centric peer-to-peer systems are very low, since they utilize the computing power, storage and bandwidth of the participating clients. There has been extensive academic and open source activity associated with improving the performance of peer-to-peer systems which has focused necessarily on improved client algorithms. Scalability tends to be high, since each new client adds some storage and bandwidth. However, since the bandwidth currently available to client computers on the internet is asymmetrical (approximately 10 times more download than upload bandwidth) there is a strong scalability limit on peer-to-peer systems in the case of widespread use of large media files. The simple boundary case requires 10 uploading peers for every downloading consumer.

No existing system addresses optimization of all the key variables: scalability, performance, cost, and commercial control. An optimal solution with great utility would be an approach that could offer the scalability and low cost of peer-to-peer client systems with the performance and commercial control characteristics of server-centric systems.

The current invention describes systems and methods for circumventing key network optimization deficiencies of both server-centric and client-centric networks by introducing a new optimization architecture based on two principals: distributed heterogeneous network intelligence with parallel data transfer from multiple sources, and co-option of non-client-or-server network infrastructure.

### SUMMARY OF THE INVENTION

Systems and methods for optimizing the utilization of heterogeneous network infrastructure so as to maximize the performance, scalability, commercial control and minimize the cost of network data transfers are described. The invention describes systems and methods for gathering network information to create distributed optimization intelligence to control the relationships of the different classes or categories of network infrastructure that are involved in a particular data transfer and systems and methods of co-opting elements of network infrastructure that are not directly under the control of the party initiating or terminating the data transfer. As well as allowing simultaneous optimization of the four key variables, the invention allows dynamic biasing of the network optimization to prioritize one or more of the key variables relative to the others.

According to the invention there is provided a system for optimizing the utilization of heterogeneous network resources in which data sets are divided into a plurality of subsets that are stored in multiple parts of the system. A plurality of end-user client computers are provided which are capable of requesting data from multiple resources on a network and reassembling pieces of data received in response to the requested data into a complete data set. A plurality of classes of network resources operate to service data transfers to the end-user client computers and one or more network coordination servers called Multi-perspective Network Optimizers coordinate access of end-user client computers to the plurality of classes of network resources. One or more sources of network information are accessible to one or more network coordination servers by making requests for information to the source that are formatted to be compatible with the source. The plurality of classes of network resources include source servers called Bound Server Resources controlled by the service provider on which data is stored for transmission to end users and peer resources called Bound Client Resources which are storage, or network transfer, or computational resources, or a combination thereof provided by said end-user client computers.

The plurality of classes of network resources further include network infrastructure servers called Unbound Network Resources which are not controlled by the service provider, but which may be utilized to optimize the overall network by servicing storage and retrieval requests, where such requests are constrained to abide by rules, interfaces and protocols of the network infrastructure servers.

A method for optimizing the utilization of heterogeneous network resources in the transmission of data sets to end-user client computers, including dividing a data set into a plurality of subsets that are stored on a plurality of classes of network resources, including, at least, a class of one or more Bound Server Resources, source servers under the control of a service provider and a class consisting of Bound Client Resources, a plurality of end-user client computers, generating a metadata description of the relation of the subsets to a complete data set and storing said metadata description on a Multi-perspective Network Optimizer coordination server, including the addresses for retrieval of the subsets and an address for the metadata description, providing to an outside application such as a browser or media player or other application running on an end-user client computer that wishes to retrieve the data set, the address for the metadata description, such that, when the address is invoked by the outside application, client software running on the end-user client computer directs the request to the coordination server, which returns the metadata description and a set of recommended addresses for retrieval of subsets of the data set to the requesting client computer, Data subsets are requested by the client computer according to the protocol type of the resource to which the request is made to a plurality of classes of network resources, and retrieving the data subsets to the end-user client computer. The data subsets are re-assembled and transferred to the media player or other application according to the protocol and/or data format required by the receiving media player or other player or other application. Upon request from a media player or other application running on the end-user client computer storing the data sub-sets in persistent storage on the end-user client computer, and upon request from another resource in the network, including another end-user client computer, retrieving and transmitting requested data sub-sets to the requesting resource, including another end-user client computer, according to the protocol of the request.

### BRIEF DESCRIPTION OF THE FIGURES

The invention itself both as to organization and method of operation, as well as additional objects and advantages thereof, will become readily apparent from the following detailed description when read in connection with the accompanying drawings:

FIG. 1A is a block diagram of a prior art system used in server-centric data transfers;

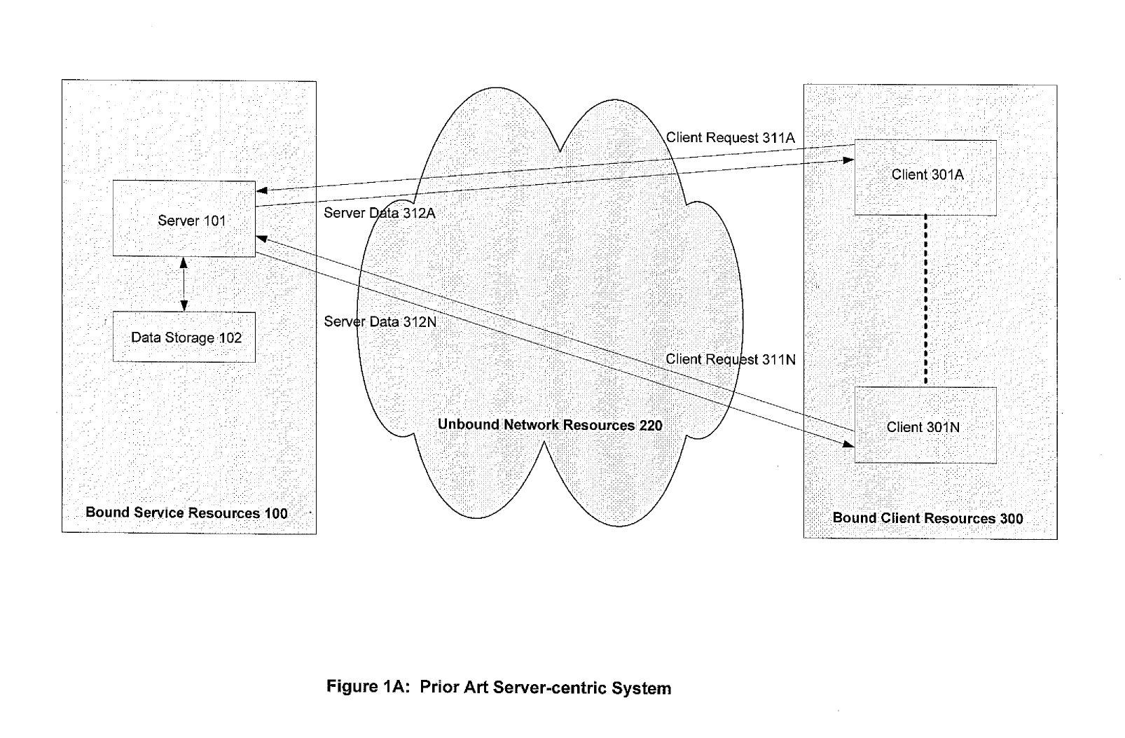

FIG. 1B is a block diagram of a prior art enhanced server-centric system;

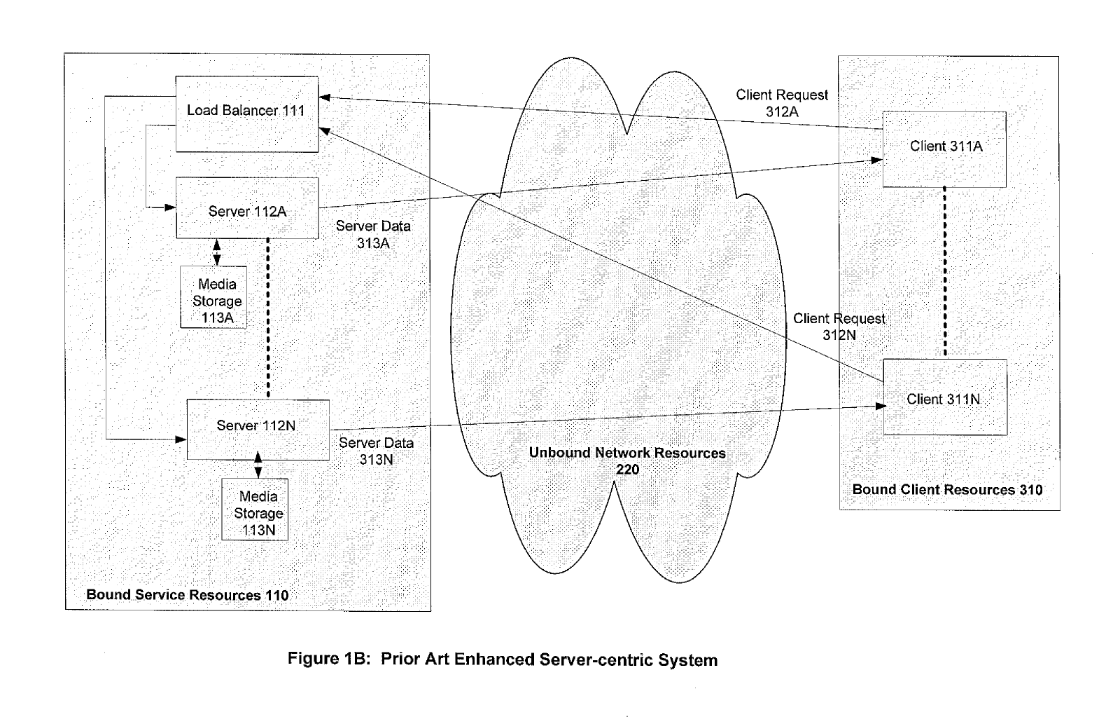

FIG. 1C is a block diagram of a prior art system used in client-centric peer-to-peer data transfers;

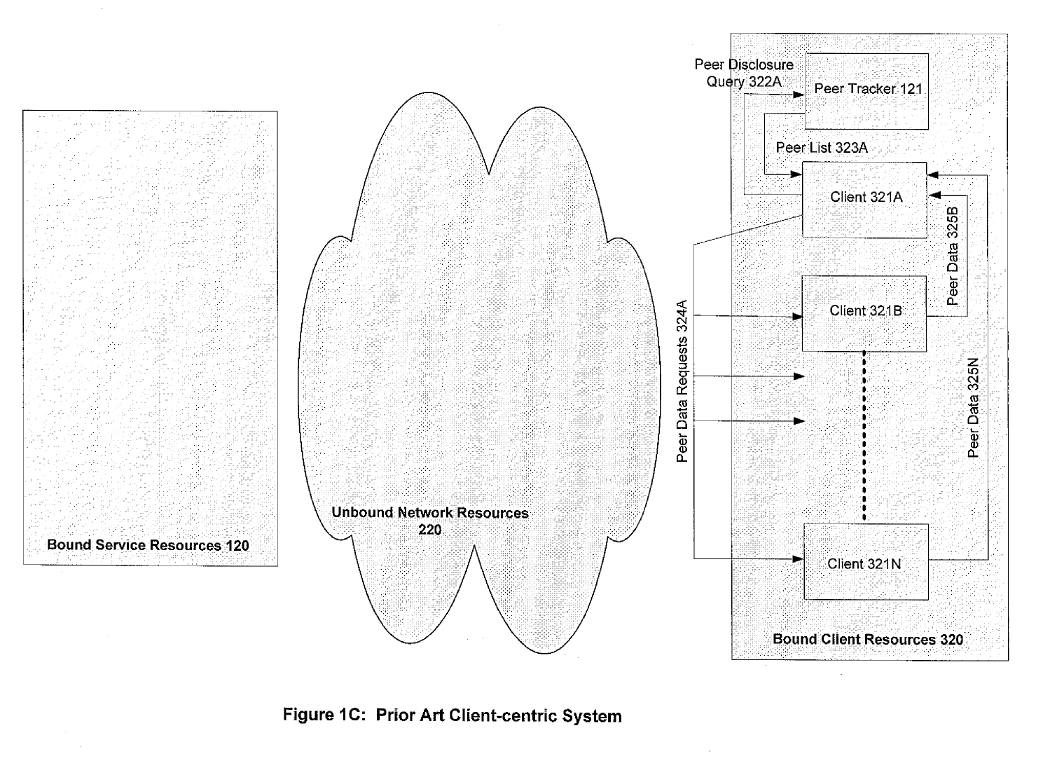

FIG. 2A is a block diagram of a preferred embodiment of the current invention that utilizes multi-perspective intelligence to optimize data transfers in the network;

FIG. 2B is a block diagram of a preferred embodiment of the current invention that optimizes the overall network by implementing commercial control over publishing data in the network and costing and payment for network data transport services;

FIG. 2C is a block diagram of a preferred embodiment of the current invention that optimizes the overall network by implementing commercial control by creating a digital rights management facility limiting consumer access to data in the network based on the fragmentation of data in a distributed heterogeneous network;

FIG. 3A is a block diagram of a preferred embodiment of the current invention that optimizes the overall network by co-opting elements of network infrastructure that are not directly under the control of the party initiating or terminating the data transfer; and

FIG. 3B is a block diagram of a preferred embodiment of the current invention that optimizes the overall network by co-opting ISP proxy-server elements of network infrastructure that are not directly under the control of the party initiating or terminating the data transfer.

### DETAILED DESCRIPTION OF THE PREFERRED EMBODIMENTS

The present invention describes a system architecture that allows exploitation of the strengths of both server-centric and client-centric systems without the deficiencies associated with either. As well, it introduces system elements and methods to co-opt network resources that are not part of either server-centric or client-centric systems. It allows optimization of scalability, performance, cost and commercial control and as well allowing a dynamic control over which of the four key variables to emphasize at the expense of others for applications with specific key requirements.

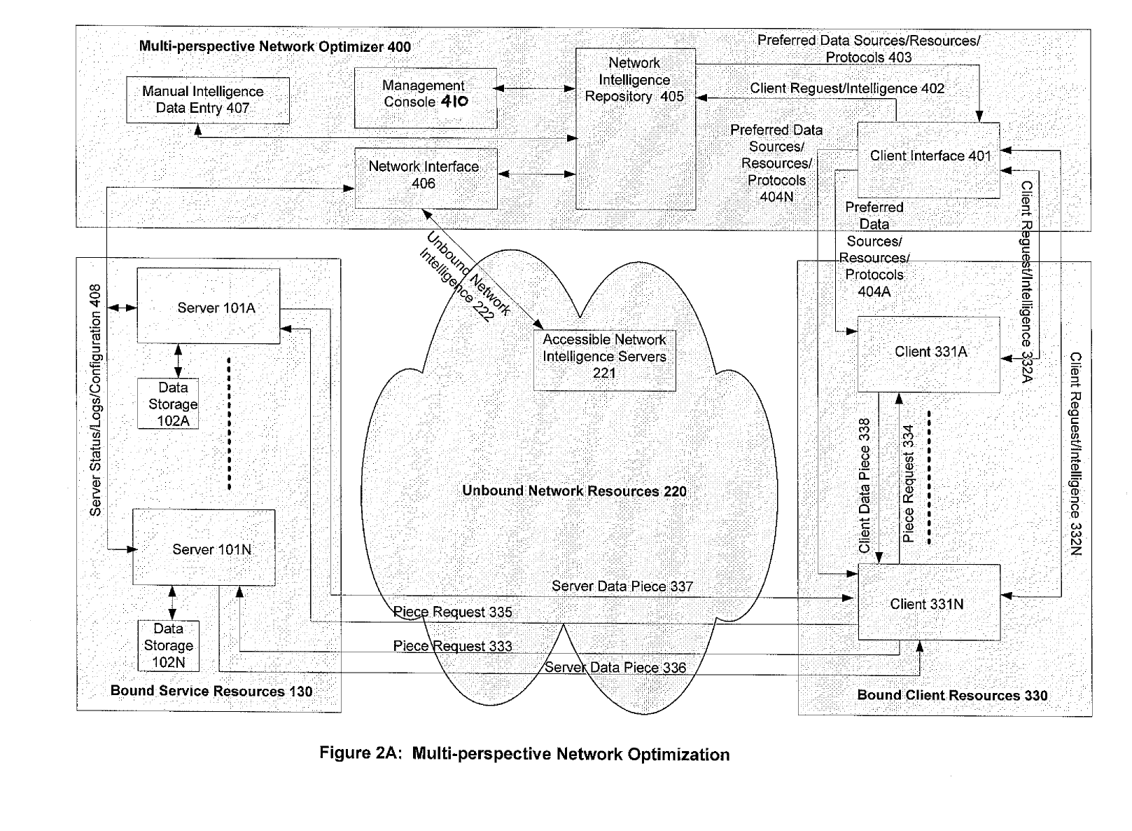

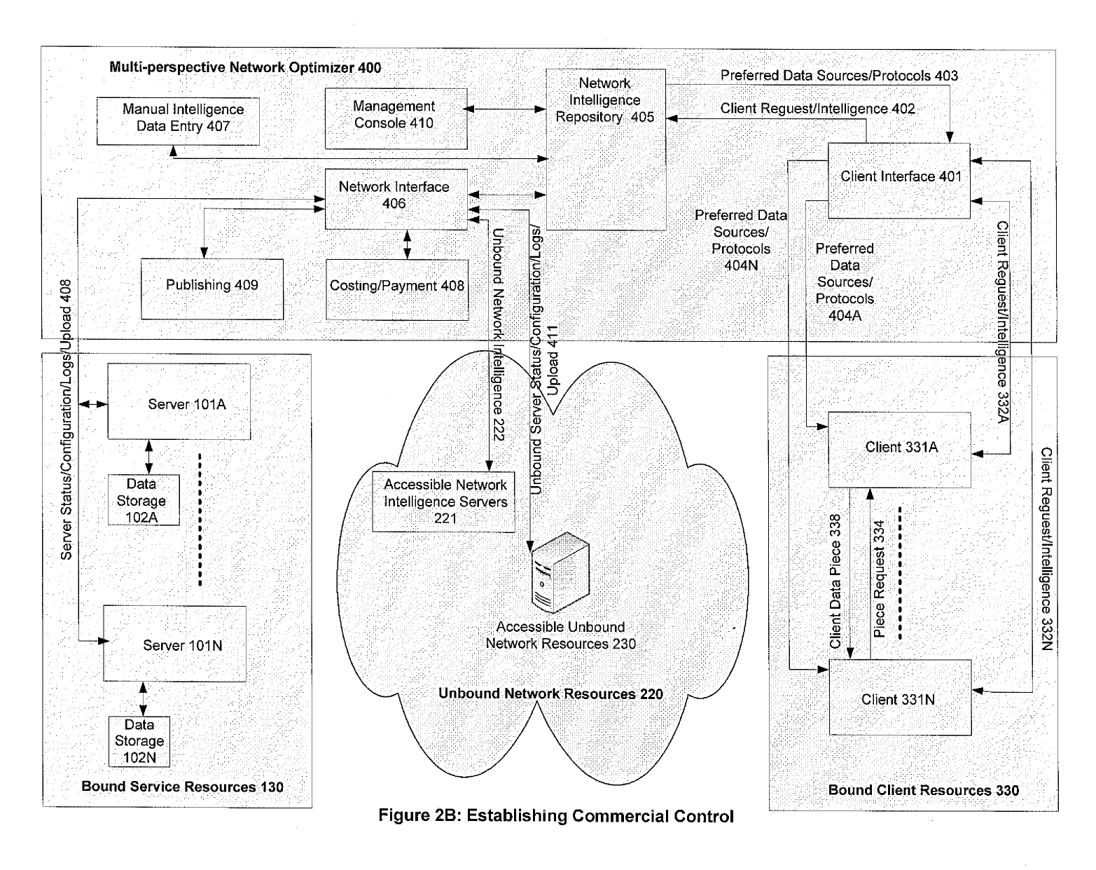

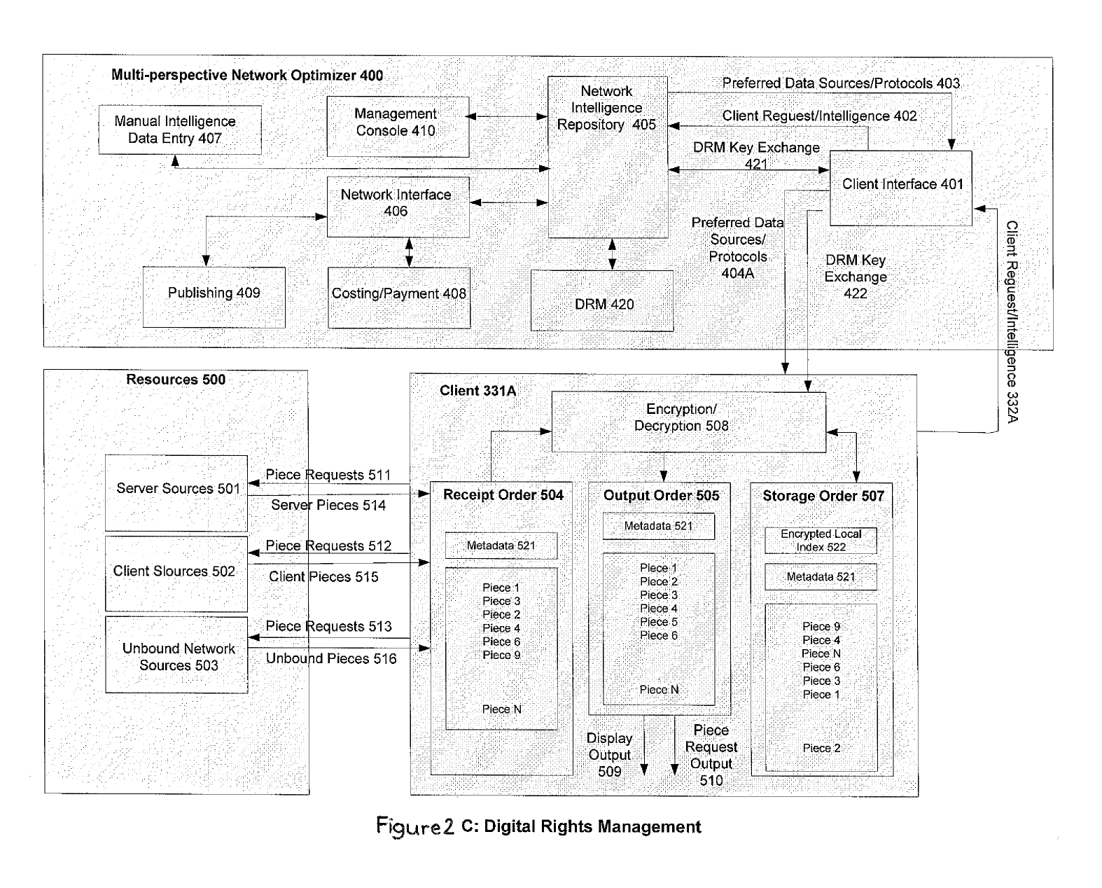

FIG. 2A shows a system used in the practice of an embodiment of the invention allowing consolidation of information derived from a server-centric view of the overall network with information derived from a client-centric view of the network. The system contains three classes of network resources, Bound Service Resources 130, Bound Client Resources 330 and Unbound Network Resources 220 organized so that network intelligence information can be gathered from each class of resources, consolidated and used to optimize network data transfers by a network coordination server, Multi-perspective Network Optimizer 400. Bound Client Resources 330 comprise a plurality of end-user client computers, Client 331A to 331N, communicating in a network such as the Internet, said client computers including mass storage capable of storing data downloaded from the network and retrieving portions of said data for upload to other computers in the network and client software that functions to provide the functions described in described embodiment of the invention. Bound Service Resources 130 comprise one or more source servers, designated Server 101A to 101N which are under the control of the data distribution service provider Said servers may be physically distributed through the network, co-located in a single facility, or even a plurality of logical servers running as software functions on a single hardware computer. Said servers include mass storage capable of storing data downloaded from the network and retrieving portions of said data for upload to other computers in the network and server software that functions to provide the functions described in described embodiment of the invention. Unbound Network Resources 220 in the described embodiment includes a plurality of sources of network information Accessible Network Intelligence Servers 221 which are not under the direct control of the data distribution service provider, but which will respond to properly formatted requests by communicating the information about the network that they contain. A network coordination server. Multi-perspective Network Optimizer 400 contains a Client Interface 401 for communicating with Bound Client Resources 330, a Network Interface 406 for communicating with source servers, Bound Service Resources 130 and Unbound Network Resources 220 and as well contains a Network Intelligence Repository 405 which consolidates, stores and retrieves information communicated from the Client Interface 401, the Network Interface 406, Manual Intelligence Data Entry 407 which allows manual entry of network information that is not directly accessible on-line and a Management Console 410.

In operation, as shown in FIG. 2A, Clients 331A to 331N request data from and deliver network intelligence to Client Interface 401 through Client Request/Intelligence Reports 332A to 332N. Servers 10A to 101N, storing data to be distributed to clients in Data Storage 102A to 102N, communicate network intelligence, server status, download logs and server configuration and data encoding formats to Network Interface 401 through Server Status/Logs/Configuration 408. Data may be complete files for download or more usually data resources broken into pieces to facilitate parallel distribution from distributed sources Descriptive metadata may be stored along with primary data or may be communicated to the optimization system. Network information from Accessible Network Intelligence Sources 221 is also communicated to Network Interface 401 through Unbound Network Intelligence 222.

The types of network intelligence gathered are diverse and potentially extremely extensive Bound Service Resources 130, for example, can provide full details of server capabilities and dynamic capacities as well as a cumulative log of all data transfers, the cost of data transfers and their characteristics as well as details of the protocols that the server supports and the encodings and characteristics of the data that it supplies Servers do not need to all service only a common protocol or data encoding.

Bound Client Resources 330 can provide, for example, data concerning clients' upload and download bandwidth relative to particular servers and clients, firewalls, proxy servers, storage capacity, available stored content, configuration, upload and download logs. Manual Intelligence Data Entry 407 allows for manual entry of intelligence data into the Network Intelligence Repository 405 in cases where useful data cannot be accessed on-line.

Accessible Network Intelligence Servers 221, can provide details of network characteristics that cannot be directly accessed from single servers or clients. For example the Border Gateway Protocol (BGP) is a protocol that describes the peering relationships of Internet Service Providers (ISPs) BGP Servers are accessible to properly formatted network queries. The Network Interface can be configured to query such BGP servers and gather intelligence that is very valuable in optimizing the performance and cost of client data requests. Other accessible network intelligence includes ISP address blocks, geographical address associations, and network bottleneck reporting.

All network intelligence data is passed from the Client Interface 401 and the Network Interface 406 to the Network Intelligence Repository 405 where it is analysed and stored so that it may be retrieved to optimize network clients and servers data transfers when data is requested by a client.

The overall function of the network coordination server Multi-perspective Network Optimizer 400 is to provide the network-wide intelligence and the resources to optimize each separate client's data requests.

To request data, a client, for example, Client 331N, communicates its request to Client Interface 401 through Client Request/Intelligence 332N. The request and any associated client intelligence are passed to Network Intelligence Repository 405 through Client Request/Intelligence 402. Network Intelligence Repository 405 retrieves the multiple sources of network intelligence available relative to the request and returns a list of optimal sources and procedures to the client through. Preferred Data Sources/Resources/Protocols 403 to Client Interface 401 where it is passed on to the client, Client 331N through Preferred Data Sources/Resources/Protocols 404N. The data sent from the Network Intelligence Repository 405 is not limited to lists of source addresses and client parameters, but can include, for example, data source addresses, source protocol, content encoding, client optimal configuration, algorithm for handling parallel requests, number of requests per resource, codec for content decoding, etc. Moreover, the resources need not be only passive data, but may include active executable code for codecs, protocol handlers, etc., so that each client is potentially a custom data retrieval program.

Client 331N uses the data, configuration, protocols, algorithms and optionally code to make data requests with the proper protocol formats to the recommended resources via Piece Request 333, Piece Request 334 and Piece Request 335. For clarity, the individual piece requests to different resources Server 101N and Server 101A and Client 331A can each be according to a different protocol and the exact number of resources addressed may vary according to the optimization goal for the particular data and requesting client. Server 101N, Client 331A and Server 101A return data pieces via Server Data Piece 336, Client Data Piece 338 and Server Data Piece 337 to Client 331N.

Client 331N, using the protocol, data encoding and optionally executable code provided by the Preferred Data/Sources/Resources/Protocols 404N communication, extracts the data pieces and assembles them in the proper order and passes the data to the media player or other application.

Even a subset of the network configuration described in FIG. 2A can be seen to have a substantial impact on network performance and efficiency. If, for instance, one limits the system to only make requests to multiple bound server resources, exemplified in FIG. 2A as Server 101N and Server 101A, one may see that a key limitation of the traditional server-centric model has been overcome. By introducing the ability for a Client 331N to request data pieces from more than one server, the efficiency barrier of traditional server-centric model has been eliminated. Preferred Data/Sources/Resources/Protocols 404N can suggest a mix of server sources to transfer parts of the requested data, each transferred on a different network path so as to cancel out the effects of network latency problems which are the key limit on efficient scaling of the traditional server-centric model. In this case, Client 331N uses the data, configuration, protocols, algorithms and optionally code to make data requests with the proper protocol formats to the recommended resources via Piece Request 333 and Piece Request 335 to resources Server 101N and Server 10A, which as above can each be according to a different protocol and the exact number of resources addressed may vary according to the optimization goal for the particular data and requesting client Server 101N and Server 101A return data pieces via Server Data Piece 336 and Server Data Piece 337 to Client 331N.

Client 331N, using the protocol, data encoding and optionally executable code provided by the Preferred Data/Sources/Resources/Protocols 404N communication, extracts the data pieces and assembles them in the proper order and passes the data to the media player or other application.

Management Console 410 provides a control point to configure the functions of the Multi-perspective Network Optimizer 400, including configuration of Bound Server Resources 130, setup of Accessible Network Intelligence Servers 221, and loading of any executable code which is loaded on the system. A central function of the Management Console 410 is to configure the Network Intelligence Repository 405 to bias the Preferred Data Sources/Resources/Protocols 403 data to allow the client to make and optimal transfer of the requested data. It may give priority to one of performance, cost, scalability or commercial control according to the agreed class of service and quality of service for the particular resource being distributed. Thus, the range of optimization includes not just optimizing the client for all data transfers, but adjusting the optimization of the client for each separate piece of requested data.

Practitioners skilled in the art will recognize that the network coordination server, Multi-perspective Network Optimizer 400 can be implemented in a number of ways without changing its essential characteristics. It could be implemented as a set of functions within a single server or even incorporated into one of the servers of Bound Service Resources 130. It could be separated into a number of separate physical or logical servers which could optionally be distributed throughout a network. Equally, it will be recognized that communication paths such as, for example, Preferred Data Sources/Protocols 404A, Client Request/Intelligence 332A, have been simplified for clarity of description and might be implemented as more complex sets of messages governed by protocol rules without changing their essential functions and methods.

As well, it will be understood that the representation of Client 331A to 331N is simplified for purposes of description of the invention and may be assumed to be a typical end-user personal computer which includes, a network interface and storage system a CPU, RAM, Display, User-interaction devices such as a keyboard and pointing device, operating system software and, in the case that the network is the internet, web browser software and that the end-user client computer is capable of installing and running application programs Equally, the ends of the invention might be served by embodying the functions of Client 331A to 331N in other types of computing devices with equivalent computing power, RAM, storage and user interaction devices and operating software capable of executing the functions of the invention. Examples of such alternate devices, among many others that will be evident to a practitioner skilled in the art will be television set-top boxes, intelligent entertainment devices, home network routers and switches and storage nodes and so on.

Equally, it will be understood that the representation of Servers 101A to 101N is simplified for purposes of description of the invention and may be assumed to be typical network server computers which include, a network interface, a CPU, RAM, Storage System, operating system software and, in the case that the network is the internet, protocol server software and commerce software adequate to support the described processes. Equally, the ends of the invention might be served by embodying the functions of Servers 101A to 101N in other types of computing devices with equivalent computing power, RAM, storage and user interaction devices and operating software capable of executing the functions of the invention. Examples of such alternate devices, among many others that will be evident to a practitioner skilled in the art will be network server appliances, routers and switches, storage systems and so on.

The data distributed in the described embodiments may be any digital data, including for example, executable application programs, utilities or operating software, source code, interpreted codes and byte-codes that execute via a virtual machine, add-on functions or data for any form of program, and data for execution on any program whether in a standardized or proprietary form, including, for example, music and/or audio data, digital photography data, graphics data and 3D model data, video and/or motion picture data, multi-media content.

FIG. 2B shows a system used in the practice of another embodiment of the invention allowing consolidation of information derived from a server-centric view of the overall network with information derived from a client-centric view of the network which enhances optimization of commercial control of the network through functions to manage publishing of data in the network and to gather the costs of and allow payment for network data transfers. The function Publishing 409 serves as an access control mechanism to establish commercial control over parties who wish to use the network to distribute data. Such parties, having established a contractual relationship with the proprietor of the distribution network, which status is entered into the Network Intelligence Repository 405, communicate with Publishing 409, which communicates with Network Intelligence Repository 405 to authenticate the publisher's status. If the publisher is authenticated, the publisher is allowed to upload the desired data into the network through Publishing 409, or alternatively to link a publisher's server, which will serve as a reference initial source for the data, to the network.

Besides access control for publishing, Publishing 409 may perform other publishing-related functions, for example dividing the data into pieces for distributed parallel transmission, scanning the data for security risks such as viruses and creating the descriptive metadata which will be transmitted along with the data.

Although the contractual relationship on which publishing authentication is based may be established by separate, non-automated methods, Publishing 409 may contain interactive functions whereby a prospective publisher may establish a contractual agreement for network data distribution online. While a commercial contractual relationship may typically imply that the publishing customer would pay for data distribution services, this invention envisages a broader sense of contractual relationship that includes free distribution services, supported by advertising revenues and which may include key issues of responsibility for legal requirements of copyright and meeting legal constraints on abusive or obscene content so that the network provider is not exposed to legal risks relating to data content.

As well as allowing publication of data into the network, Publishing 409 provides functions to allow the publisher to unpublish data, that is, to prevent users from accessing the data. Such a function is essential to publishers' commercial control of their intellectual property, or simply to allow control over versions of the data. It is a function that is significantly absent from client-centric systems that have no centralized point from which to control of the network.

Costing/Payment 408 is a function that allows further optimization of commercial control over the network It extracts cost and related service data from the various categories of network resources Bound Service Resources 130, Bound Client Resources 330 and Unbound Network Resources 220, which are communicated to the network coordination server Multi-perspective Network Optimizer 400 via the respective network intelligence messages Server Status/Configuration/Logs/Upload 408, Client Request/Intelligence 332A to 332N, Unbound Network Intelligence 222 and Unbound Server Status/Configuration/Logs/Upload 411. The extracted information is stored in Network Intelligence Repository 405.

The cost and related service information is used for two primary purposes. The first function is to optimize network transfers for different classes of service and quality of service. In previous network architectures, the classes and quality of service have been relatively fixed in that all data transmissions use the same resources in the network This invention allows data distributors to establish different classes and qualities of service and then optimize the network to provide a cost and performance appropriate to each class and quality of service. For instance, a data service that offers real time streaming of High Definition cinema is substantially more demanding than overnight file delivery of standard television resolution video. The costs associated with the various resources of the overall network vary over a wide range as do the transmission characteristics associated with each resource. For example, Bound Service Resources 130 have a relatively high cost and potentially a high quality of service if the loads are kept below peak capacity of the servers. Bound Client Resources 330 have a low relative cost and, individually, a low quality of service, which may, however, be mitigated by mobilization of large numbers of clients in parallel. Unbound Network Resources 220 vary widely in both cost and quality of service. Gathering cost and performance data for all resources allows optimization for each desired class and quality of service delivered to a customer to either achieve the desired quality of service at the lowest price, or alternatively, to achieve the greatest profit margin to the network for a fixed price.

The second function of the Costing/Payment 408 subsystem is to keep track of the actual classes and qualities of service and aggregate services performed by the network so that clients may be billed on the basis of service delivered. The other side of billing for service is paying for the constituents of the services rendered. It is clear that the network operator must pay directly for the costs of the Bound Service Resources 130 and the Multi-perspective Network Optimizer 400. What is not so clear is that from a multi-perspective viewpoint, the same costs may be perceived differently depending on from which role or position in the network one looks. For example, the cost of client upload bandwidth from the client's perspective may be essentially zero if we assume that the client pays a monthly fixed charge, so that not using bandwidth already paid for generates no savings and using it generates no extra cost. However, from the ISP's viewpoint, using the paid-for but latent bandwidth generates extra costs. The costs may be minimal if the data traffic stays within the ISP's network, or substantial if the traffic passes outside the ISP's network. The true cost of bandwidth is usually multi-perspective. This invention allows the assignment of cost to all network transfers in order to implement the ultimate commercial control where all suppliers of bandwidth, including ISPs and end-user clients are compensated for their contribution with a payment system that parallels the billing for services delivered to the data distributor customer. Management Console 410 and Manual Intelligence Data Entry 407 are the functional units that allow setting of cost against class and quality of service and distributing payment credits to the various suppliers of network resources.

FIG. 2C shows a system used in the practice of another embodiment of the invention allowing consolidation of information derived from a server-centric view of the overall network with information derived from a client-centric view of the network which enhances optimization of commercial control of the network through digital rights management (DRM) functions which exploit distributed data to control user access to data transferred by the network. Unlike many encryption-based DRM systems the present invention does not rely on bulk encryption of data content to prevent unauthorized access to data, but exploits the partitioning of data that is used to allow parallel transmission of distributed data to make it extremely difficult for unauthorized parties to access the data in a usable form.

As in other embodiments of the invention, one or more network coordination servers represented by Multi-perspective Network Optimizer 400 consolidates network information about the locations, characteristics and encodings of data on resources throughout the network, Resources 500, which consists of Server Sources 501, Client Sources 502 and Unbound Network Sources 503. A data transfer is initiated by a Client 331A requesting data from the network through Client Request/Intelligence 332A to Client Interface 401 and passed on by Client Request/Intelligence 402 to Network Intelligence Repository 405, which as well as details of the locations and characteristics of all data in the network contains details of the permissions allowed to clients and encryption key information generated by DRM 420. Network Intelligence Repository 405 replies to the data request with Preferred Data Sources/Protocols 403 and DRM Key Exchange 421 to Client Interface 401 which passes the information on to Client 331A as Preferred Data Sources/Protocols 404A and DRM Key Exchange 422 passed to Encryption/Decryption 508. Client 331A requests the data pieces from the network resources as designated by Preferred Data Sources/Protocols 404 with Piece Requests 511, 512 and 513. The requested pieces are transmitted to Client 331A as Server Pieces 514, Client Pieces 515 and Unbound Pieces 516 where they are placed into a receiving RAM buffer Receipt Order 504, one of the pieces being Metadata 521 which is an index of the order of the data pieces encrypted with the request key. The order of the data is not important at this time. The data is passed to Encryption/Decryption 508 where one of two order transformations is performed. The first is Output Order 505 which transforms the data into its natural order for display output Display Output 509. The second is to another scrambled order, Storage Order 507 governed by a local encryption key which generates an Encrypted Local Index 522, this data is then written to disk. The data from disk may be returned to natural Display Output 509 for redisplay However, this natural order cannot be copied since it is only passed to the display system Copying the Storage Order 507 to another client computer will not allow access unless a local encryption key is provided by the DRM system.

One other access to Storage Order 507 is required. Client 331A may be requested by another client to respond to piece requests similar to Piece Requests 512 to Client Sources 502. Such requests are retrieved from Storage Order 507 through Encryption/Decryption 508 decoding of Encrypted Local Index 522 and output through Output Order 505 not in natural display order, but in the arbitrary order imposed on the Piece Requests by the DRM encryption system Piece Request Output 510.

It will be clear to a skilled practitioner that such an arrangement is not totally secure The actual content data is not hard encrypted, but is transformed into arbitrary order of parts. The data probably could be reordered by brute force analysis, but the process would be complex and hard to generalize to different data instances. The described embodiment is useful in that it places a barrier before the average user that prevents simple copying and forces the skilled transgressor into means which are clearly illegal, which simplifies the process of enforcing the rights holders rights through legal as opposed to technical channels and contributes to commercial control of the network.

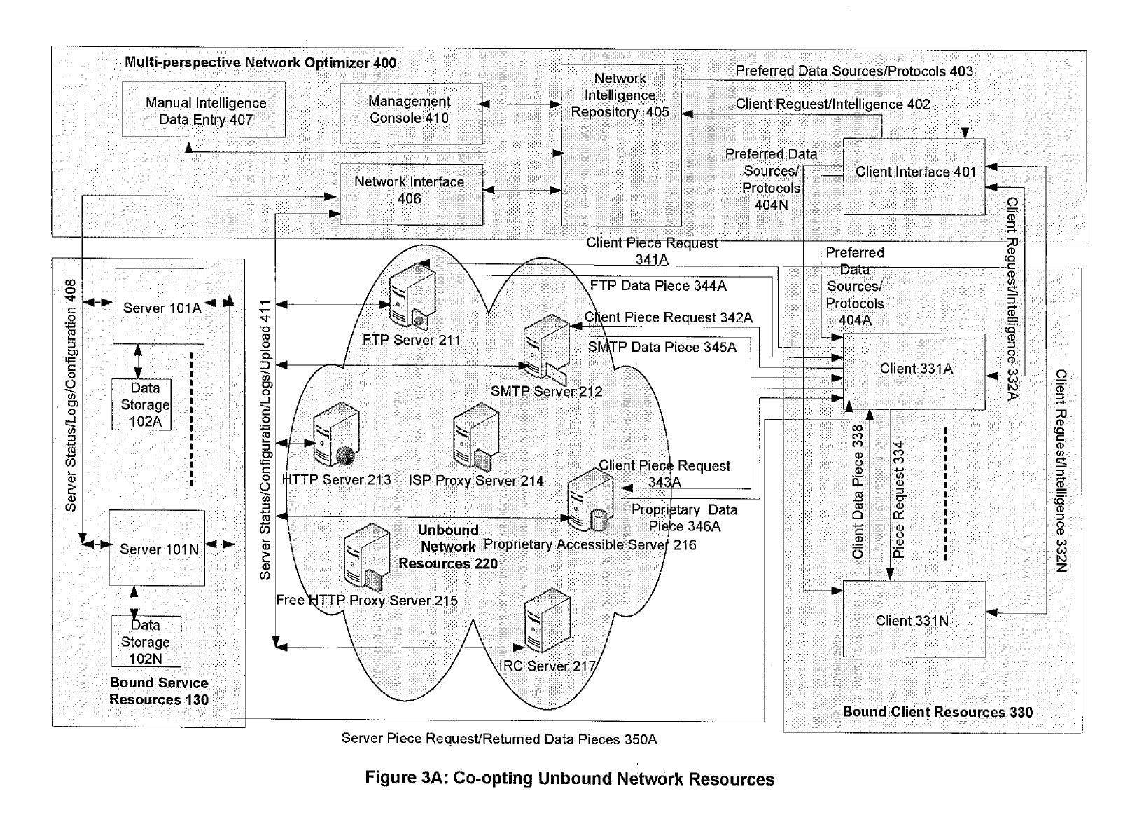

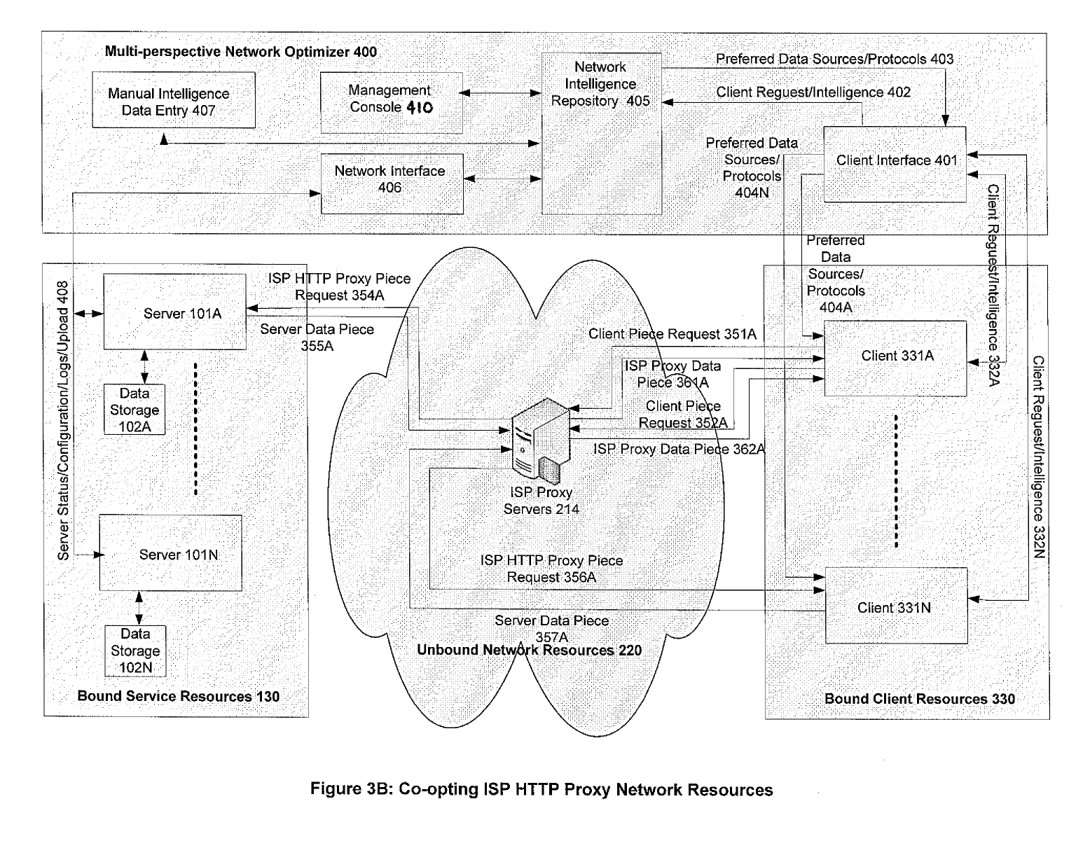

FIG. 3A shows a system used in the practice of another embodiment of the present invention in which Unbound Network Resources 220 are co-opted to provide storage and transmission bandwidth in the distribution of requested data in support of Bound Client Resources 330 and Bound Service Resources 130 under coordination of one or more network coordination servers represented by Multi-perspective Network Optimizer 400. Unbound Network Resources 220 includes an exemplary range of unbound server resources to give a concrete impression of the breadth of this class of resources, including FTP Server 211, SMTP Server 212, HTTP Server 213, Free HTTP Proxy Server 215, IRC Server 217 and Proprietary Accessible Server 216. Other types of unbound network resources are possible within this category which has been represented as Accessible Unbound Network Resources 230 in FIG. 2B. The essential characteristic of this class of resources is that they are existing network resources available to store and retrieve data without being installed and maintained by the distribution network owner. The internet has many such resources that are owned and maintained by individuals and organizations and made accessible for general use. They even include large commercial resources like Google that allow user access to store and receive types of data, email and video for instance, although they otherwise may offer products or services for sale. The essential characteristic of this category of resources is that the Multi-perspective Network Optimizer 400 be able to arrange the storage of data on the target resource and provide a client with configuration, protocol, codec and other capabilities adequate to retrieve the data and to combine it with pieces of data available from other resources to reconstitute a complete requested data resource.

It will be noted that ISP Proxy Server 214 is not addressed in this embodiment This is because the ISP Proxy Server 214 is one of a special class of unbound network resource that provides a service to users of a network, but is largely invisible to those users and cannot be directly accessed and co-opted as a data resource by the Multi-perspective Network Optimizer 400 through the Network Interface 406. This is an important class of unbound network resources and will be dealt with separately in FIG. 3B.

In this embodiment, the network coordination server, Multi-perspective Network Optimizer 400 first arranges the storage of all or part of the data that is to be distributed on the target resource, for example FTP Server 211, using the native protocol and data encoding, if any, of the server. Often manual intervention may be required, which will be achieved through Management Console 410, Manual Intelligence Data Entry 407 and Publishing 409. For example, it may be required to set up access and authentication passwords. All the details of the resource are stored on Network Intelligence Repository 405 including, for example capacities and costs. While there are many freely accessible resources available on the internet, there is no barrier to using the same setup procedures to create service accounts on resources that offer service for payment, with the corollary that Multi-perspective Network Optimizer 400 will only encourage use of such resources when the service agreement with a data distributor customer is able to absorb the cost.

After a resource is recruited into the overall distribution network, if Client 331A makes a data request for a data resource stored in part or whole on that resource through Client Request Intelligence 332A and subsequently Client Request Intelligence 402, Network Intelligence Repository 405 may include that resource in Preferred Data Sources/Protocols 403 and 404A as long as the cost, performance and other optimization parameters set through Management Console 410 suggest that it is an appropriate resource for the class of service and quality of service associated with the data resource. In FIG. 3A, Preferred Data Sources/Protocols 404A to 404N include requests to servers, a client, and multiple unbound network resources Client 331A requests pieces from the recommended servers through Server Piece Request/Returned Data Pieces 350A, to Client 331N through Piece Request 334 and to unbound network resources through Client Piece Request 341A, 342A and 343A Each client piece request is in the protocol of the destination resource, in this case FTP, SMTP and Proprietary respectively Responding to properly formed requests, the resources reply with data pieces in their respective protocols and encodings, Server Piece Request/Returned Data Pieces 350, Client Data Piece 338 and FTP Data Piece 344A, SMTP Data Piece 345A and Proprietary Data Piece 346A.

As the data pieces are delivered to Client 331A, each piece must be received in the protocol of the sending resource, the data payload extracted, possibly transformed into another encoding and the pieces reassembled in the order of the requested file or stream and then communicated to the application(s) which will interpret, display or further process the data. Clearly, this requires a polymorphic adaptable client that can interleave transactions in multiple protocols and data encodings. Thus, it is a function of this invention that Clients 331A to 331N be able to be configured or updated in response to Preferred Data Sources/Protocols 404A to 404N instructions and that optionally such instructions even include executable code modules for protocols or codecs or data encryption/decryption or other processing functions so that they may request and consume or supply data in any format that the network coordination server Multi-perspective Network Optimizer 400 supports Such polymorphism assures that any accessible resource in the network can be mobilized to provide a service that is optimal in regard to cost, performance, scalability and commercial control in ways that are inaccessible to single perspective network architectures relying solely on bound resources of a single class.

FIG. 3B shows a system used in the practice of another embodiment of the present invention in which ISP Proxy Servers 214, a special class of Unbound Network Resources 210 which are not directly accessible, are co-opted to provide storage and transmission bandwidth in the distribution of requested data in support of Bound Client Resources 330 and Bound Service Resources 130 under coordination of one or more network coordination servers represented by Multi-perspective Network Optimizer 400. As noted above in discussion of FIG. 3A, proxy servers form a special class of unbound network resource in that Multi-perspective Network Optimizer 400 cannot directly set up storage and retrieval on the proxy. Instead a proxy intercepts a request for data on another resource and retrieves it to the proxy on behalf of the party that made the request, then sends it on to the requesting party. In certain cases, for example anonymizing proxies, that is all that the proxy does. But in most cases the proxy also includes a cache and if the data it retrieves meets the rules set by the proxy or those built into the protocol it services, it will store a copy of the data in its cache. Then, when a subsequent request for the same data is received by the proxy, the proxy does not go to the source for the data but returns it to the requester directly from its cache.

This is the primary reason that proxy servers are deployed extensively by ISPs If the same data is retrieved repeatedly by many of the ISPs customers, use of a proxy allows the ISP to provide a higher quality of service to more customers for less cost. Data served from the proxy cache is typically of higher quality of service than data from the original source because it is “closer” to the customer with fewer intervening nodes to traverse from the proxy than from the original source. It is less costly to the ISP because the ISP need not pay internetwork transit charges for data delivered to its customers from a proxy inside its own network, whereas multiple transfers of large data from outside sources generate significant charges.

This is a root reason that extensive P2P data traffic is seen as negative by ISPs. It raises their internetwork transit costs by transferring data between clients inside and outside their network.

Notionally, proxy caches could be used for data traffic on any protocol. However, historically, ISPs have only implemented proxy caches for well-understood standard protocols that represent the majority of their traffic In practice, that means that the only widely deployed proxy caches in ISP networks are HTTP proxy servers, represented in FIG. 3B as ISP Proxy Servers 214 because the majority of traffic that the ISP services is transferring HTTP web pages.

In the practice of this invention, to co-opt ISP HTTP Proxy Servers 214 requires coordination of a number of resources that the network coordination server Multi-perspective Network Optimizer 400 controls, in order to harvest high performance and low cost bandwidth from the proxy server which it does not directly control. In this case there is no overt setup and upload of data to the resource Instead, requests from Bound Client Resources 330 for data pieces on the servers and clients in both Bound Service Resources 130 and Bound Client Resources 330 must be made to meet strict rules for content cacheability. And the data pieces returned from the source resources to the proxy server must be configured to meet the criteria that the proxy uses to decide if content is suitable for caching.

FIG. 3B shows an example with two requests for data pieces from Client 331A One is to Server 10A as Client Piece Request 351A and the other is to Client 331N as Client Piece request 352A ISP Proxy Servers 214 receive each request and in turn makes the requests to Server 10A as ISP HTTP Proxy Piece Request 354A and to Client 331N as ISP HTTP Proxy Piece Request 356A. Server 101A returns the requested piece to ISP Proxy Servers 214 as Server Data Piece 355A and Client 331N returns Server Data Piece 357A. ISP Proxy Servers 214 then completes the loop by returning the requested pieces to Client 331A as ISP Proxy Data Piece 361A and ISP Proxy Data Piece 362A. If the form of the requests and the data is properly structured, any subsequent request for the same data will be sent to the requesting client directly from ISP Proxy Servers 214 rather than from Server 101A and Client 331N.

However, simply requesting the data with a valid HTTP command is not adequate to ensure cacheability. There are a numerous valid HTTP requests which will produce responses that will not be retained in the ISP proxy cache.

HTTP contains a number of directives that prevent an HTTP response from being cached:
no-cache: The cache cannot serve a cached response without revalidating with the origin server
no-store: The cache must not cache the response for servicing subsequent requests. The cache must make every effort to remove the response from both volatile and permanent storage.
private: will prevent all caching in public caches
max-age=0, s-maxage=0. This will force an immediate revalidation of the HTTP response for every subsequent request.
HTTP/1.0 used a “Pragma: no-cache” header directive to prevent caching of HTTP/1.0 requests/responses. HTTP/1.1 must treat this header the same way as it treats “Cache-Control: no-cache”.
If the cache contains no validator (such as a Date or ETag header), or does not provide and expiry time (Expires header), then it should not be cached. However, it is acknowledged that some caches violate this rule It would probably be safe to assume that professional cache products will conform to this rule.
   Additionally, HTTP Proxy Cache Servers implement rules outside the basic HTTP directives that block cacheing for various reasons. For example, caches will attempt to detect application-server activity by looking for specific strings on a request URI in order to disallow caching of a response that is programmatically generated. This is done because the data returned by such requests is typically different for each request and hence cacheing and returning the same data is counterproductive. As well, a number of security problems may ensue from cacheing such data. The common Squid proxy, for example, is packaged with a default to not cache any responses to requests containing “cgi-bin” or “?”. More modern caches would additionally look for “cgi”, “php”, “pl”, “asp”, “jsp”, “py” and other scripting language extensions that would indicate a dynamic response generation mechanism.

Some P2P systems use HTTP as a convenient transport protocol, but cannot take advantage of ISP proxy caches because of one or more classes of either missing or malformed directives or extra disallowed content in the HTTP request.

This embodiment of the current invention introduces a number of methods to recruiting ISP proxy caches as resources in a data distribution network:
1. The first and simplest approach is to create HTTP requests from the client that as well as implementing all of the proper HTTP cacheability directives, do not contain any extra application server or dynamic content typical characters that might trigger anti-cacheing rules in the ISP Proxy Servers 214. The request could simply address the resource by its IP address followed by a path to the data, for example:
   GET http://192.168.1.1/content/part
   This would work adequately in systems that exploited only one source for the data, but in a distributed system making parallel requests to a large number of sources it would be ineffective because, although the ISP proxy server would cache the content, it would only give the content back to a client requesting the exact same resource address, which defeats the purpose of making diverse parallel requests in the first place. Ideally, we want the data to stay in the cache and to be returned to any requesting client no matter where they think the data source is.
2. This deficiency in directly addressing the host resource can be remedied by changing the resource software so that it behaves in a non-standard way to HTTP requests.
   A P2P system that wanted to take advantage of caching would simply need to fix the host IP address in its HTTP requests so that any cache receiving or intercepting the request would be directed at a specified server with all the content. However, other nodes in the P2P system would ignore the host information encoded in the HTTP request. The request URI could look like:
   GET http://192.168.99.99/content/piece
   If this request is sent to a cache, it would connect to the server at 192.168.99.99. However, if the request message is sent to a client with the special client rules software present on either end of the link, it can ignore the host resource information One P2P client (client 1) could connect to another P2P client (client 2) on an IP address like 10.1.2.3, and send the above URI, and the other client would simply ignore the server IP address and return the requested data ignoring the host field.
   If an interception cache was present, or the request was sent to an explicit cache, the cache, lacking the code directives to ignore the host field, would behave in the correct HTTP protocol fashion and would connect to the source specified by the IP address and retrieve and cache the data. All subsequent requests for that same resource from other clients to the cache will receive cached data.
   The disadvantage of this approach is that a single designated server would have to contain all of the data and service all cache requests.
3. The problem of resolving all cache requests to a single address can be remedied by using a DNS name in the request rather than an IP address in the host field of the request URI. This will have the same result as using an IP address, except it allows for more flexibility in that multiple servers in multiple locations could be used to satisfy the proxy requests, resulting in increased scalability. In this case, the request could look like:
   GET http://www.itiva.com/content/piece
   Again, the DNS name of the server is ignored by other clients that contain code directives to not follow standard HTTP rules, however if an ISP proxy, lacking such special code, receives this request, it would resolve the host name www.itiva.com, which would then through DNS return the IP address of a server which would return the requested data.
4. A preferred embodiment of the invention further eliminates the problem of associating the requested data with a particular host The disadvantage to the both methods 2. and 3. above is that the designated server(s) would have to contain all the data that is available on the network in order to take advantage of caches. An alternative preferred embodiment that would remedy the concentration of data requests on specifically designated server or servers is to modify the software of the server that is the designated host, in example 2. 192.168.99.99 and example 3 www.itiva.com, so that it is a modification of a standard HTTP server which would parse out the content part of the request, content/piece, and pass that as a request to a resource designated by the Network Intelligence Repository 405. Thus, the designated host would serve as a HTTP load balancer rather than the direct supplier of the content. And the storage and transmission of the content can be decentralized to any appropriate resource known by the Network Intelligence Repository 405.
5. Another preferred embodiment achieves the same result. This preferred embodiment assigns a DNS name to the actual data instead of naming the server resource A DNS service in the Client Interface 401 in cooperation with the Network Intelligence Repository 405 can resolve the request to be served by any resource in the network. Thus potential bottlenecks in serving proxy requests are eliminated and the network servers need not contain all or any of the content.
   For example, a request using this method of the invention might take the following form:
   GET http://server.p0.testmovie.itiva.net:25111/64/HTTP/11
   Connection: close
   User-Agent: Qmesh
   Host: server.p0.testmovie.itiva.net:25111
   The response is:
   HTTP/1.1 200 OK
   Connection: close
   Date: Tue, 15 Nov. 2005 08:12:31 GMT
   Server: QMesh Server
   Transfer-Encoding: chunked
   The response will be fully cacheable in any HTTP cache such as ISP Proxy Server's 214.

The ability to co-opt the resources of ISP proxy servers in the distribution of data and avoiding the necessity of centralizing data on particular servers as described in the various methods of this embodiment of the invention provide substantial benefits in optimizing performance, cost and scalability of data distribution networks. It addresses performance optimization by using high performance infrastructure that is very close to the requesting client. It addresses scalability limitations of P2P architectures by adding high performance bandwidth that makes up in part for the asymmetry of download and upload bandwidth that limits scalability. It addresses cost in two senses First, the proxy bandwidth is essentially free from the perspective of the end user and the data distributor. Second, it actually reduces the cost of the ISP by using the ISP proxy infrastructure to keep data transfers within their networks, avoiding internetworking transfer fees for repeated data transfers. This benefit to the ISP in lowering their cost eliminates the primary motivation that ISPs have to limit the performance of P2P systems, thereby undermining their cost/performance ratios. The provision of a preferred method involving data content naming rather than resource naming enhances the scalability and flexibility of the system.

While the particular embodiments of systems and methods for optimizing the utilization of network infrastructure so as to maximize the performance, scalability and commercial control and to minimize the cost of network data transfers as herein shown and described in detail are fully capable of attaining the above-described objects of the invention, it is to be understood that they are the presently preferred embodiments of the present invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

We claim:

1. A system for optimizing the utilization of heterogeneous network resources in which data sets are divided into a plurality of multiple subsets that are stored in multiple parts of the system which includes:
(a) a plurality of end-user client computers capable of requesting data from multiple resources on a network and reassembling pieces of data received in response to the requested data into a complete data set;
(b) a plurality of classes of network resources to service data transfers to said end-user client computers;
(c) one or more network coordination servers that coordinate access of end-user client computers to said plurality of classes of network resources;
(d) one or more sources of network information which is accessible to one or more network coordination servers by making requests for information to the source that are formatted to be compatible with the source;
(e) wherein said plurality of classes of network resources include:
(i) source servers controlled by the service provider on which data is stored for transmission to end users; and
(ii) peer resources which are storage, or network transfer, or computational resources, or a combination thereof, provided by said end-user client computers.

2. A system for optimizing the utilization of heterogeneous network resources in which data sets are divided into a plurality of subsets that are stored in multiple parts of the system infrastructure which includes:
(a) a plurality of end-user client computers capable of requesting data from multiple resources on a network and reassembling subsets of data received in response to a data request into a complete data set;
(b) a plurality of classes of network resources to service data transfers to end-user client computers;
(c) one or more network coordination servers that coordinate access of end-user client computers to said plurality of classes of network resources;
(d) one or more source of network information which is accessible to one or more network coordination servers by making requests for information to the source that are formatted to be compatible with the source;
wherein said plurality of classes of network resources include:
(i) source servers controlled by a service provider on which data is stored for transmission to end users
(ii) peer resources which are storage, or network transfer, or computational resources, or a combination thereof, provided by end-users' client computers;
(iii) network infrastructure servers which are not controlled by the service provider, but which may be utilized to optimize the overall network by servicing storage and retrieval requests, where such requests are constrained to abide by rules, interfaces and protocols of the network infrastructure servers.

3. A system according to claim 1, wherein a plurality of source servers is deployed without any resources in the Peer resource class or the Network Infrastructure class, the deployment including:
(a) a plurality of end-user client computers capable of requesting data from multiple network resources and reassembling subsets of data into a complete data set;
(b) one or more network coordination servers that coordinate access of said end-user client computers to multiple network resources to service data transfers to end-user client computers;
(c) one or more source of network information which is accessible to one or more network coordination servers by making requests for information that are formatted to be compatible with the source.

4. A system according to claim 2, wherein a plurality of source servers is deployed without any resources in the Peer resource class or the Network Infrastructure class, the deployment including:
(a) a plurality of end-user client computers capable of requesting data from multiple network resources and reassembling subsets of data into a complete data set;
(b) one or more network coordination servers that coordinate access of said end-user client computers to multiple network resources to service data transfers to end-user client computers;
(c) one or more source of network information which is accessible to one or more network coordination servers by making requests for information that are formatted to be compatible with the source.

5. The system of claim 1, 2 or 3 wherein end-user client computers contain software functions that enable simultaneous communication with multiple source servers or network infrastructure servers according to a plurality of protocols including HTTP, FTP, SMTP, IRC, RTP, RTSP, RTMP and streaming and other protocols which may be implemented on a plurality of source servers.

6. The system of claim 1, 2 or 3, wherein said end-user client computers contain software functions that enable reassembling data subsets into complete data sets according to protocols which include HTTP, FTP, SMTP, IRC, RTP, RTSP, RTMP, MMS and file transfer, streaming and other application protocols which may be implemented in the media player or other application to which the client is transferring data.

7. The system of claim 6, wherein said protocol for transferring data to a media player or other application is the same as the protocol for transferring data to a source server or network infrastructure server.

8. The system of claim 6, wherein said protocol for transferring data to a media player or other application is different from the protocol for transferring data to a source server or network infrastructure server.

9. The system of claim 1, 2 or 3, wherein said end-user client computers contain software functions that enable them to download code that allows them to execute new protocols, codecs, and transfer algorithms to interact with diverse server resources in the network.

10. The system of claim 1, 2 or 3, wherein said end-user client computers contain software functions to re-order data subsets that have been transmitted in a scrambled order by a Digital Rights Management system and assemble the data subsets in the order of an original data set and transfer the data set to a media player or other application upon presentation of an authorized DRM key.

11. The system of claim 10, wherein said end-user client computers contain software functions to store and optionally encrypt subsets of information in the scrambled order transmitted by a Digital Rights Management system and to re-transmit the subsets in scrambled order when requested by an external peer request, but re-order and assemble the data subsets in the order of the original data set and transfer the data set to a media player or other application upon presentation of an authorized DRM key.

12. The system of claim 1, 2 or 3, wherein said end-user client computers and source servers contain software to log data requests, data receptions and transmission rates and interactions between the data transfer functions and data requests from applications, including a media player application and return said log data to said one or more network coordination servers.

13. The system of claim 1, 2 or 3, wherein said end-user client computers are one or more dedicated-function electronic devices with computing capability, including:
set-top boxes that couple an end-user television or monitor to a network, home network gateway devices that serve to distribute data from a network to devices in the end-user's home, consumer electronics devices, including televisions, radios and other information presentation devices with embedded network connections and computing functions, or other home computing devices which combine network connectivity and computing capability.

14. The system of claim 1, 2 or 3 wherein said one or more of the coordination servers include a subsystem for gathering information from said source servers concerning availability and performance of the server relative to serving requests from different ones of said end-user client computers in the system so that said subsystem may optimize data transfers on the basis of performance.

15. The system of claim 1, 2 or 3, wherein said one or more of the coordination servers include a subsystem for gathering information from client computers concerning availability and performance of the client relative to providing peer resources from the client to other clients in the system so that said subsystem may optimize data transfers on the basis of performance.

16. The system of claim 1, 2, or 3, wherein said one or more network coordination servers include a publishing subsystem which controls and manages entry and withdrawal of data into said source servers.

17. The system of claim 1, 2, or 3, wherein said one or more network coordination servers include a costing system which provides information on the cost of transfers of data from different data sources of the system so that said coordination server can optimize the choice of data sources based on cost.

18. The system of claim 1, 2, or 3, wherein said one or more network coordination servers include a pricing system which provides information on the pricing of transfers of data to customers of the system so that the coordination server can optimize the choice of data sources based on cost relative to a price agreed by a customer.

19. The system of claim 1, 2, or 3, wherein said one or more network coordination servers include a DRM subsystem which manages key distribution and data subset order scrambling of data where publishers of the data choose to limit access to the data to end-users that have acquired a DRM key.

20. The system of claim 1, 2, or 3, wherein said one or more source of network information which is accessible to one or more network coordination servers is manual information entered into said system by a human operator
a The system of claim 1, 2, or 3, wherein said one or more source of network information is an automated query to an element of network infrastructure accessible to formatted external queries
b The system of claim 21, wherein said one or more source of network information is a Border Gateway Protocol server.

23. The system of claim 1, 2, or 3, wherein one or more of a class of said source servers controlled by a service operator is an HTTP server, an FTP server, an IRC server, an SMTP server, or a server of another publicly defined file transfer protocol.

24. The system of claim 1, 2, or 3, wherein one or more of a class of said source servers controlled by a service operator is an RTP, RTSP server, or other publicly defined streaming protocol.

25. The system of claim 1, 2, or 3, wherein one or more of a class of said source servers controlled by a service operator is a server executing a privately defined file transfer protocol.

26. The system of claim 1, 2, or 3, wherein one or more of a class of said source servers controlled by the service operator is a streaming server executing a privately defined streaming protocol, including Adobe RTMP, Microsoft MMS, or other privately defined streaming protocol.

27. The system of claim 2, wherein one or more of a class of network infrastructure servers is an HTTP server, an FTP server, an IRC server, an SMTP server, or a server of another publicly defined file transfer protocol.

28. The system of claim 2, wherein one or more of a class of said network infrastructure servers is an RTP, RTSP, or other publicly defined streaming protocol.

29. The system of claim 2, wherein one or more of a class of network infrastructure servers is a server executing a privately defined file transfer protocol.

30. The system of claim 29, wherein one or more of a class of said network infrastructure servers is a streaming server executing a privately defined streaming protocol such as Adobe RTMP, or Microsoft MMS, or other privately defined streaming protocol.

31. A method for optimizing the utilization of heterogeneous network resources in the transmission of data sets to end-user client computers whereby,
(a) dividing a data set into a plurality of subsets that are stored on a plurality of classes of network resources, including, at least, a class of one or more source servers under the control of a service provider and a class consisting of a plurality of end-user client computers,
(b) generating a metadata description of the relation of the subsets to a complete data set and storing said metadata description on a coordination server, including the addresses for retrieval of the subsets and an address for the metadata description,
(c) providing to an outside application such as a browser or media player or other application running on an end-user client computer that wishes to retrieve the data set, the address for the metadata description, such that, when the address is invoked by the outside application, client software running on the end-user client computer directs the request to the coordination server, which returns the metadata description and a set of recommended addresses for retrieval of subsets of the data set to the requesting client computer,
(d) requesting data subsets by the client computer according to the protocol type of the resource to which the request is made to a plurality of classes of network resources, and retrieving the data subsets to the end-user client computer,
(e) re-assembling the data subsets and transferring them to the media player or other application according to the protocol and/or data format required by the receiving media player or other player or other application, upon request from a media player or other application running on the end-user client computer,
(e) storing the data sub-sets in persistent storage on the end-user client computer, and
(g) upon request from another resource in the network, including another end-user client computer, retrieving and transmitting requested data sub-sets to the requesting resource, including another end-user client computer, according to the protocol of the request.

32. A method for optimizing the utilization of heterogeneous network resources in the transmission of data sets to end-user client computers comprising,
(a) dividing a data set into a plurality of subsets that are stored on a plurality of classes of network resources, including, at least, a class of one or more source servers under the control of a service provider and a class consisting of one or more network infrastructure servers not under the control of the service provider and optionally a class consisting of peer resources on end-user client computers, where
(b) requesting storage and retrieval of data sub-sets on said servers will be executed if the requests conform to the protocol and data formats of the server, notwithstanding that the sources in the class of network infrastructure servers are not under the control of the service provider, so that protocol and format routines may be executed on a coordination server and the data sub-sets stored on the network infrastructure servers are available to retrieval requests,
(c) generating and storing on a coordination server, a metadata description of the relation of the sub-sets to the complete data set including the addresses for retrieval of the sub-sets, the protocol and data format requirements of each server and an address for the metadata description,
(c) providing the address for the metadata description to an outside application such as a browser or media player or other application running on a end-user client computer that wishes to retrieve the data set,
(e) directing the request to said coordination server by client software running on the end-user client computer when the address is invoked by the outside application, which coordination server in response to the request, returns the metadata description and a set of recommended addresses for retrieval of subsets of the data set to the requesting client computer,
forming requests to source server class resources through its client software, and network infrastructure class resources and optionally peer resource class resources for the data subsets according to the protocol type of the source to which the request is made, and retrieving the returned data subsets to the end-user client computer,
(g) re-assembling the data-subsets and transferring them to the media player or other application according to the protocol and/or data format required by the receiving media player or other application, upon request from a media player or other application running on the end-user client computer,
(h) storing the data subsets in persistent storage on the end-user client computer, and
(i) upon request from another resource in the network, including another end-user client computer, retrieving and transmitting requested data sub-sets to the requesting resource, including another end-user client computer, according to the protocol of the request.

32. A method for optimizing the utilization of heterogeneous network resources in the transmission of data sets to end-user client computers, comprising:
(a) dividing a data set into a plurality of subsets that are stored on a plurality of source server resources,
(b) generating a metadata description of the relation of the sub sets to the complete data set and storing said metadata description on a coordination server, including addresses for retrieval of the subsets and an address for the metadata description,
(c) providing the address for the metadata description to an outside application such as a browser or media player or other application running on a end-user client computer that wishes to retrieve the data set,
(d) directing the request to the coordination server, by means of client software running on the end-user computer, when the address is invoked by the outside application, wherein said coordination server returns the metadata description and a set of recommended addresses for retrieval of subsets of the data set to the requesting client computer,
(e) forming requests to a plurality of source servers for the data subsets according to the protocol type of the source server to which the request is made through the requesting client computer's client software, and retrieving the data subsets to the end-user client computer,
(f) re-assembling the data-subsets and transferring them to the media player or other application according to the protocol and/or data format required by the receiving media player or other application.

34. The method of claim 31, 32 or 33, wherein storage of data sub-sets on source servers is achieved by:
processing the original data set to divide it into data subsets according to the protocol and data format of each target source server,
creating a metadata descriptive file for the data set, including an address for the whole data set and a set of addresses associated with each data subset,
uploading the data subsets and metadata file to the target source servers.

35. The method of claim 32, 33 or 34, where storage of data subsets on source servers is achieved by:
at each target source server, processing the original data set to divide it into data subsets according to the protocol and data format that particular source server, and
at each target source server, creating a metadata descriptive file for the data set, including an address for the whole data set and a set of addresses associated with each data subset.

36. The method of claim 32 and 33, where storage of data subsets on end-user client computers is achieved by;
after an end-user has requested a data set and has received the metadata file and data subsets associated with that request,
store the metadata and data subsets associated with that request in persistent storage on the receiving end-user client computer.

37. The method of claim 31 and 32, where storage of data subsets on end-user client computers is achieved by:
sending a command from the coordination server to the client software on the end-user's computer to cause it to request the data set or subset thereby forcing a transfer without the end-user's intervention in order to force distribution of the metadata file and data subsets associated with that request, and
storing the metadata file and data subsets associated with that request in persistent storage on the receiving end-user client computer.

38. The method of claim 32, 33 or 34, where the coordination server controls each introduction of a new data set with a set of steps to:
(a) authenticate the user's right to publish the data set into the system and to initiate any other procedures relative to the data set;
(b) provide status feedback on the state and history of each data set published;
(c) delete or inactivate any data set.

39. The method of claim 31 to 32, wherein the coordination server, from data concerning the cost of transfers from each network resource of the system which stores the requested data set or subsets:
(a) creates a list of resources that have the lowest aggregate cost of transfer for each individual request from an end-user and;
(b) returns the list of suggested sources for data subsets to the requesting end-user client computer.

40. The method of claim 31, 32 or 33, wherein said the coordination server, from data concerning the anticipated performance of transfers from each network resource of the system which stores the requested data set or subsets;
creates a list of resources ranked as to performance in transferring data sub-sets to the individual end-user's client computer and
returns a list of suggested high performance sources for transferring the requested data sub-sets to the requesting end-user client computer.

41. The method of claim 31 and 32, where the coordination server, from data concerning the anticipated performance of transfers from each source server of the system which stores the requested data set or subsets;
(a) creates a list of source server resources ranked as to performance in transferring data sub-sets to the individual end-user's client computer and
(b) returns a list of suggested high performance sources for transferring the requested data subsets to the requesting end-user client computer; and
(c) client software on the end-user client computer independently calculates a list of peer resources ranked as to performance in transferring data subsets to the end-user's client computer, and
(d) merges the list of high performance server sources with the list of high performance peer sources to create a final list of suggested high performance sources for transferring the requested data subsets to the requesting end-user client computer.

42. The method of claim 31, 32 or 33, wherein the coordination server, from data concerning the anticipated availability of transfers from each network resource of the system which stores the requested data set;
(a) creates a list of resources ranked as to availability in transferring data subsets to the individual end-user's client computer and
(b) returns a list of suggested under utilized or high availability sources for transferring the requested data subsets to the requesting end-user client computer in order to load balance the system, use resources efficiently and not overload any resource in the system.

43. The method of claim 31 or 32, wherein the coordination server, from data concerning the anticipated availability of transfers from each source server of the system which stores the requested data set;
(a) Creates a list of source server resources ranked as to availability in transferring data subsets to the individual end-user's client computer and
(b) returns a list of suggested under utilized or high availability source servers for transferring the requested data subsets to the requesting end-user client computer; and
client software on the end-user client computer independently calculates a list of peer resources ranked as to availability in transferring data subsets to the end-user's client computer and
merges the list of available server sources with the list of available peer sources to create a final list of suggested high availability or under utilized sources for transferring the requested data subsets to the requesting end-user client computer in order to load balance the system and use resources efficiently and not overload any resource in the system.

44. The method of claim 31, 32, 33, 34, 35, 36, 37, 38, 39, 40, 41, 42 or 43, wherein the coordination server, for each end-user request, creates a list of preferred sources that merges cost, performance and availability of resources to create a source list that delivers a balance of highest performance, at lowest cost, with the most balanced and efficient use of overall network resources.

45. The method of claim 32, 33 or 34, where the methods of claims 40, 41, 42, 43 or 44 are merged and the coordination server:
for each end user request, consults metadata fields for the data set which record the publisher's specification of a desired priority of cost versus performance
creates a list of preferred sources that represents the specified trade-off between cost and performance, and
merges that list with a list of availability of resources to create a source list that delivers the specified performance versus cost with the most balanced and efficient use of overall network resources.

46. The method of claim 31, 32 or 33, where the coordination server implements a Digital Rights Management system by ordering the transmission of data subsets in a pseudo-random sequence according to an encryption key, so that:
when the data subset sequence is received by an end-user client computer the order of the data subsets can only be discovered by application of the appropriate key to the metadata description that is transferred along with the data subsets, and after application of the key, the end user client computer, upon request from a media player or other application running on the end-user client computer, re-assembles the data subsets in the original data set order and transfers them to the media player or other application according to the protocol and/or data format required by the receiving media player or other application.

47. The method of claim 46, where the coordination server implements a key management protocol between the coordination server and the end-user client computer.

48. The method of claim 47, where the end-user client computer stores the received data subsets in local persistent storage, maintaining the pseudo-random sequencing of data subsets, until:
(a) requested by a local application such as a media player or other application to transfer the data set, whereupon, on presentation of a correct authorized key, it transfers the data sub-sets in the correct order, or,
(b) on being requested by a local or remote application, according to the correct protocol, but without an authorized key, it transfers the data subsets in the same pseudo-random sequence as they were originally received, along with an encrypted metadata description of the data subsets, or,
(c) on being requested by a local or remote application, according to the correct protocol, but without an authorized key, it transfers the data subsets in a new pseudo-random sequence according to a new encryption key, along with an encrypted metadata description of the data sub-sets.

49. The method of claim 31, 32 or 33, wherein one or more of the class of network infrastructure servers not under the control of the service provider is a cacheing proxy server, whereby a request to a target source for a data subset is passed through an intervening proxy server, which, if it is capable, according to the protocol of the request, will process the request and return the requested data subset on behalf of the target resource, and wherein
(a) said coordination server shapes the request according to the protocol of the target resource and the intervening proxy server, and beyond simple compliance with the protocol, further shapes the request to add such directives as to assure that the data sub-set will be cached by the intervening proxy server if the data sub-set is not already in the cache of the intervening proxy server, according to the following steps;
(b) said coordination server shapes the request to not include, even if they may be valid directives or information of the protocol, directives and information that typically-configured cacheing proxy servers of the particular protocol would interpret as directives or heuristics to not cache the requested data subsets, and
(c) said coordination server shapes the size of the data subsets to correspond to the size of data that is most likely to be cached by a typically-configured cacheing proxy of the particular protocol, and
(d) the coordination server shapes the request and the address of the requested data set or sub-sets so that when the data set or sub-sets are cached in response to a request from one target resource of the system for a data set or sub-set, then,
(e) a subsequent request to another source for the same data set or subsets will appear to be a request for the same data set or subset, notwithstanding that it was delivered from a different resource in the system, and hence will be returned from the cache rather than the target resource from which it is being requested.

50. The method of claim 50, wherein the cacheing proxy server is an HTTP cache proxy server, and said coordination server shapes all suggested resource requests so that the request:
(a) will include and properly set all HTTP directives necessary for allowing cacheing of a data set or data sub-set, including, for example, but not limited to, a Date or ETag header and Expires header, and,
(b) does not include directives that would prevent cacheing of a data set or subset, including, for example but not limited to, no cache, no store, private, max-age=0, s-maxage-0, and
(c) does not, include strings in the request URI that would indicate dynamic content or other class of content that would typically be blocked from cacheing by the proxy cache, including, for example, but not limited to the strings ?, &, cgi-bin, php, pl, isp, jsp, py
(d) limits the size of data subsets to a size that typical HTTP proxy caches will not reject as too large for cache efficiency and reject for cacheing,

51. The method of claim 50, where the cacheing proxy server is an HTTP cache proxy server,
(a) the coordination server shapes all suggested resource requests so that the request implements a URI naming scheme that allows cacheing, including, for example, but not limited to, a URI scheme that gives the host address of the target resource, followed by a path to the content, such as:
GET http://<host IP address>/data set/data subset,
Eg. GET http://192.168.99.99/content/part, and optionally,
in the end-user client computer software, implements a procedure to ignore the host address in the request
This allows a client to make a request to another host, such as a peer, but a standard proxy server, without the skip host address procedure, will be constrained to serve the request if the data set or subset is in cache, or return to the original host address to refresh the cache if the data set or data subset is not present. This method introduces a limitation in the system to a single designated host source.

52. The method of claim 51, where the cacheing proxy server is an HTTP cache proxy server,
the coordination server shapes all suggested resource requests so that the request implements a URI naming scheme that allows cacheing, including, for example, but not limited to, a URI scheme that gives the host DNS name instead of host IP address of the target source, followed by a path to the content, such as:
GET http://<host DNS name>/data set/data subset,
Eg. GET http://host1.itiva.net/content/part, and optionally,
In the end-user client computer software, implements a procedure to ignore the DNS in the request.

53. The method of claim 52, where the cacheing proxy server is an HTTP cache proxy server, with the introduction a modification of the software of the source server that is the designated host to create a modification of a standard HTTP server which:
parses out the content part of the request URI, content/piece, and passes that as a request to a source designated by the coordination server.

54. The method of claim 51, where the cacheing proxy server is an HTTP cache proxy server, and
(a) the coordination server shapes all resource requests so that the request implements a URI naming scheme that allows cacheing, including, for example, but not limited to, a URI scheme that assigns a DNS name to the content data set or subset instead of to the host source, such as,
GET http://<data set name>.<network domain name>/<path>,
Eg. GET http://movie1.itiva.net/piece1,
thereby allowing a DNS server in the system to resolve the request and direct it to any resource in the system, unbinding the content from particular host sources.

55. The method of claim 54, where the naming scheme is extended to include more information about the class of sources that should be addressed by a particular request,
(a) the coordination server shapes all suggested resource requests so that the request the request implements a URI naming scheme that allows cacheing, including, for example, but not limited to, a URI scheme that assigns an extended DNS name to the content data set or sub-set including desired source class or other information, such as,
GET http://<source class>.<data set name>.<network domain name>/<path>,
Eg GET http://sourceservers.movie1.itiva.net/piece1,
which allows a DNS server in the system to resolve the request and direct it to any source within a specific class of sources in the system.

56. The method of claim 50, 51, 52, 53, 53, 54 or 55, where the cacheing proxy server is an HTTP cache proxy server, and further flexibility of sizing data transfers can by achieved by breaking data subsets into smaller data sub-subset request units by utilization of HTTP range requests, such that,
A request for a data subset can be combined with multiple requests for data sub-subsets within the data subset
described are provided by reduction to custom hardware components or sub-systems such as a co-processor board plugging into the bus of the respective computer systems, or a custom integrated circuit, or as firmware, microcode or physical circuitry on CPU of the local or remote computer.

57. A method of manufacture of any of the component parts of the systems described in claims 1 to 31 whereby the software functions of the coordination server, or the source servers, or the system client software of the end-user client computers are pre-installed in the process of assembly and testing.

58. A method of manufacture of any of the component parts of the systems described in claims 1 to 31 whereby the software functions of the coordination server, or the source servers, or the system client software of the end-user client computers are pre-installed after assembly and testing in the process of distribution in advance of sale to the end-user.

59. A method of manufacture of any of the component parts of the systems described in claims 1 to 31 whereby the software functions of the coordination server, or the source servers, or the system client software of the end-user client computers are integrated with the hardware elements in the field after the hardware is deployed in the field.

60. A method of manufacture of any of the component parts of the systems described in claims 1 to 31 whereby the software functions of the coordination server, or the source servers, or the system client software of the end-user client computers are provided by reduction to custom hardware components or sub-systems such as a co-processor board plugging into the bus of the respective computer systems, or a custom integrated circuit, or as firmware, microcode or physical circuitry on CPU of the local or remote computer.

61. A computer-readable medium having stored thereon a computer software embodying the software functions of the coordination server, or the source servers, or the system client software of the end-user client computers of the systems described in claims 1 to 31.
